(19) United States
(12) Patent Application Publication
(10) Pub. No.: US 2010/0057767 A1
(43) Pub. Date: Mar. 4, 2010

(54) SYSTEM AND METHOD FOR DYNAMICALLY CREATING AND/OR UPDATING SUBSCRIBER COMMUNICATIONS LISTS

(76) Inventors: Sharon Fridman, London (GB); Craig Haupt, Twickenham (GB)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/212,385

(22) Filed: Sep. 17, 2008

Related U.S. Application Data
(60) Provisional application No. 61/093,143, filed on Aug. 29, 2008.

(51) Int. Cl. G06F 17/30

(52) U.S. Cl. 707/102; 707/E17.005

(57) ABSTRACT

A system and method are disclosed herein for dynamically updating a first subscriber communications list or creating a new subscriber communications list based on awareness information data, the method comprising creating a rule for defining a second subscriber communications list, the second subscriber communications list being an updated first subscriber communications list or being a created new subscriber communications list; storing the rule; retrieving and pre-processing existing data; retrieving and pre-processing the awareness information data; and storing the second subscriber communications list.

### PRIORITY INFORMATION

The present application claims priority under 35 U.S.C. § 119(e) to U.S. Provisional Patent Application No. 61/093,143, filed Aug. 29, 2008, the entire contents of which are herein expressly incorporated by reference.

### BACKGROUND

1. Field of the Invention

The present invention relates to communications systems. More particularly, the present invention relates to a system and method for dynamically updating one or more subscriber information data in one or more subscriber communications lists and/or dynamically creating subscriber information data to create or modify one or more subscriber communications list associated with the subscriber and/or the subscriber's watchers based on presence information associated with the subscriber.

2. Background Information

In communication systems, such as a fixed, wireless, or converged networks, network operators utilize service enablers to deliver communications services to users and others associated with the network, herein generally “subscriber” or “subscribers,” as defined further below. To operate properly for an individual subscriber, communications services require one or more subscriber and/or policy data to tailor settings, permissions, and preferences to that individual.

The data, herein generally “subscriber information data” (SID) are aggregated in one or more lists, herein generally “subscriber communications lists” (SCL), that are manipulated by one or more rules. For example, a SID may be the telephone contacts in the subscriber's contact list, e.g., the SCL, in a cellular telephone or the contacts in a buddy list, e.g., the SCL, in an instant messaging system. SCLs remain static until a subscriber revises his SID by adding new contacts or updates his preferences, e.g., preference rules, for his existing SID. SCLs also remain static until a service enabler promulgates a policy change, e.g., a change in the policy rules.

An SCL having variable a SID is utilized in connection with a presence server. A network operator utilizes a presence server to detect the status of a network subscriber. At its most simplistic, the presence server detects the ON or OFF status, i.e., presence status of a subscriber. That is, the presence server determines that the communications device of a requisite subscriber is operative with the network or that it is inoperative. The functionality of that information may be extended beyond the network operator to the subscribers of that or other associated networks.

In its most common incarnation, a buddy list uses a presence agent to enable a subscriber, a “watcher,” to subscribe to the status of another user or subscriber, the “object.” To do so, the watcher enters identification data of the object into a presence agent, which typically requests authorization from the object to watch. The object can authorize or decline the request; thus, applying a temporary rule or make the same rule permanent. If the watcher is authorized, the SID is modified to include the object and the SCL then indicates the object in the watcher's presence list.

Even if authorized, the object may apply a rule to limit the watcher's access to the object's status information by adding the watcher's identification data to a temporary or permanent rule that blocks the watcher in a SID of a block list.

More sophisticated presence detection is also possible. By integrating readily applicable rules, e.g., subscriber-selectable choices, such as ON—DO NOT DISTURB, the object can indicate its ability, i.e., status, to engage in communication. This rule change is then reflected in the watcher's presence list. Since most watchers subscribe to a plurality of subscribers, the “presence list” is constantly updated by the manual actions of the objects.

Certain communications services may create SIDs that link to other data or rules that link data. For example, IM conversations, e.g., SID, may be stored and are accessed via a “session history list,” e.g., SCL, that is created by the network operator in response to a subscriber's preference settings, e.g., the subscriber's rules.

Numerous protocols are available to regulate SIDs, SCL, presence agents, and data formats in communication systems of any type. One format is Session Initiation Protocol (SIP) and SIP for Instant Messaging and Presence Leveraging Extensions (SIMPLE) based IM and presence systems. Such systems are described in, for example: Internet Engineering Task Force (IETF), Network Working Group, Request for Comments (RFC) 3428, “Session Initiation Protocol (SIP) Extension for Instant Messaging” (December 2002); IETF, Network Working Group, RFC 3856, “A Presence Event Package for the Session Initiation Protocol (SIP)” (August 2004); IETF, Network Working Group, RFC 3863, “Presence Information Data Format (PIDF)” (August 2004); IETF, Network Working Group, RFC 2778, “A Model for Presence and Instant Messaging” (February 2000); IETF, Network Working Group, RFC 2779, “Instant Messaging/Presence Protocol Requirements” (February 2000); and IETF, Network Working Group, RFC 3261, “SIP: Session Initiation Protocol” (June 2002).

Functionally, SCLs of the prior art are static. In other words, once a list has been created, either by the subscriber or by the system, deliberate steps would have to be taken to modify the list. For example, a subscriber would need to manually edit his buddy list by adding or removing a new object.

Other types of SIDs and SCLs are similarly static and quickly lose their usefulness. A subscriber's contact list may include invalid telephone numbers from former contacts or require management by sorting contacts into appropriate groups.

Thus, what is desired is a method and a communication system for updating one or more subscriber communications lists dynamically based on presence information associated with the subscriber. More particularly, what is desired is a system and method for dynamically updating one or more subscriber communications lists and/or dynamically creating one or more subscriber communications lists based on awareness information.

### SUMMARY OF THE INVENTION

It is therefore a general aspect of the invention to provide a system and method for dynamically updating one or more subscriber communications lists and/or dynamically creating one or more subscriber communications lists based on awareness information that will obviate or minimize limitations of the type previously described. These and other objectives are provided for in the present invention.

In accordance with one or more embodiments of the present invention, a method of dynamically updating a first subscriber communications list or creating a new subscriber communications list based on awareness information data, the method includes creating a rule for defining a second subscriber communications list, the second subscriber communications list being an updated first subscriber communications list or being a created new subscriber communications list; storing the rule; retrieving and pre-processing existing data; retrieving and pre-processing the awareness information data; and storing the second subscriber communications list.

In accordance with one or more embodiments of the present invention, a system for dynamically updating a first subscriber communications list or creating a new subscriber communications list based on awareness information data includes a rules engine module for creating and registering a rule, the rule for defining a second subscriber communications list, the second subscriber communications list being an updated first subscriber communications list or being a created new subscriber communications list; and a system database module for storing the first subscriber communications list and the rule, wherein the rules engine module process the aware information data according to the rule and generates the second subscriber communications list.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system and method for dynamically updating and/or dynamically creating one or more subscriber communications lists based on awareness information according to an embodiment of the present invention.

FIG. 2 is a flow diagram of a method for dynamically updating one or more subscriber communications lists and/or dynamically creating one or more subscriber communications lists based on awareness information according to an embodiment of the present invention.

FIG. 3 is a diagram illustrating several factors that can influence the rules engine module according to an embodiment of the present invention.

FIGS. 4a-4e are block diagrams of the system of FIG. 1 illustrating one or more methods for dynamically updating a subscriber communications list according to an embodiment of the present invention.

FIG. 5 is a block diagram illustrating a communications system in relation to other functional elements it operates alongside for dynamically updating and/or dynamically creating one or more subscriber communications lists based on awareness information according to an exemplary embodiment of the present invention.

### DETAILED DESCRIPTION OF THE PREFERRED EMBODIMENTS

The various features of the preferred embodiments will now be described with reference to the drawing figures, in which like parts are identified with the same reference characters. The following description of the presently contemplated best mode of practicing the invention is not to be taken in a limiting sense, but is provided merely for the purpose of describing the general principles of the invention.

### I. DEFINITIONS

The following definitions will be instructive in understanding the various exemplary embodiments.

Presence Service: A Presence Service is a service that serves to accept information, store it, and distribute it. The information stored is

Presence Information: Presence Information is the information stored in the presence server.

Presentities: Presentities are clients of the presence server that provides presence information that is stored in the presence server and distributed from it elsewhere.

Watchers: Watchers are also clients of the presence server that receive presence information from the presence server. There are two kinds of watchers: Subscribers and Fetchers.

Subscribers: Subscribers are watchers that requests notification from the presence service of future changes in some presentities presence information.

Fetcher: Fetchers are watchers that can request the current value of some presentities presence information from the presence service.

Non-cognizant Members: Non-cognizant members are members of a list of non-watchers and non-subscribers, whereby the non-cognizant members become members of the list by virtue of an external trigger, not caused by the non-cognizant member. As those of ordinary skill in the art can appreciate, a non-cognizant member can be an application (software program), or a person.

Uniform Resource Identifier: A uniform resource identifier (URI) is a compact string of characters for identifying an abstract or physical resource. URIs provide a simple and extensible means for identifying a resource. A URI can be further classified as a locator, a name, or both. A URI can act as a pointer to actual identifying data. Further, the term “Uniform Resource Locator” (URL) refers to the subset of URI that identify resources via a representation of their primary access mechanism (e.g., their network “location”), rather than identifying the resource by name or by some other attribute(s) of that resource. The term “Uniform Resource Name” (URN) refers to the subset of URI that are required to remain globally unique and persistent even when the resource ceases to exist or becomes unavailable.

Identifier: Identifier data is data or information from which another entity, whether that entity is an application or person, can derive the real name of the application and/or person associated with the particular identity.

Subscriber Information Data: Subscriber information data (SID) comprises any suitable data that can occur and/or can be captured in relation to a subscriber, an object that the subscriber is watching, and/or a watcher who watches the subscriber. SID can also include such data that may be removed by one or more levels from the subscriber; for example, SID can also include data from a watcher who is watching the watcher of the subscriber. SID includes data that has presence, profile (dynamic, static) and, according to further exemplary embodiments, supplementary identifications. SID can include data that is similar to URI's and identifiers.

A UCL is a generic communications list.

Subscriber Communications List: A subscriber communications list (SCL) is an arrangement of one or more subscriber information data that can be arranged in one or more subscriber communications lists. SCLs can be dynamically updated and/or created based on awareness information (subscriber information data).

Block List: A block list is an example of an automatically updated list. The list contains entities that a user wishes to forbid to see the user's presence.

Usage Awareness Data (UAD): Usage awareness data comprises a network operator's knowledge regarding usage history of the network, including calling and instant messaging data or logs, session histories in instant messaging programs, locations from which communications are made, lengths of communications, persons contacted, and any data determined by data mining and/or cross-referencing.

### II. System and Method for Dynamically Creating and/or Updated Subscriber Communication Lists

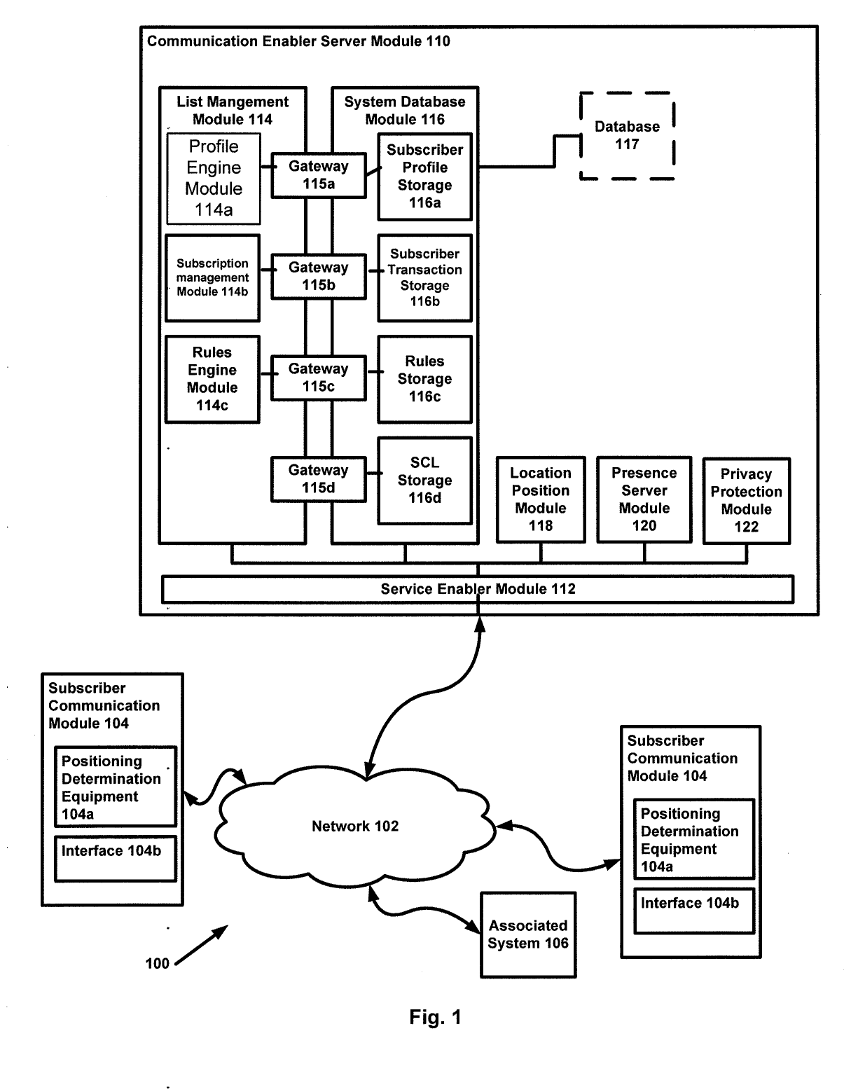

FIG. 1 is a block diagram illustrating a system and method for dynamically updating one or more subscriber communications lists and/or dynamically creating one or more subscriber communications lists based on awareness information.

A communication system 100 provides any suitable type of communication and/or communication service. System 100 includes a communication enabler server module 110 that is in communication via one or more networks 102 with one or more subscriber communication modules 104, each of which is associated with a respective subscriber of the system. Furthermore, system 100 may also be used by an associated system 106, which may be any suitable authorized or predetermined user, application, network, subscriber, user, regulatory and/or governing body.

A subscriber may be any person, user, or entity that receives communication services and/or information trough the network whether or not a contractual obligation, e.g., subscription, exists between the subscriber and the network. A subscriber, therefore, can be a person, group of people; it can be an organization or a group of organizations, or it can be an application, or a group of applications that represent one or more people or organizations.

A network 102 may comprise any suitable type of wireless and/or wired communication network, such as fixed, wireless, and/or converged network. The network may be operated or otherwise managed by any appropriate type of network operator, including, but not limited to, a Mobile Network Operator (MNO), a mobile virtual network operator, a wireless service provider, a wireless carrier, a mobile phone operator, a cellular company or organization, a fixed network operator, a converged network operator, or any suitable combination thereof.

Although one network 102 is be illustrated, it should be appreciated that any suitable number (e.g., network 1, network 2, network 3, . . . , network M, where M is any appropriate number) and kinds (e.g., wired, wireless, or combination thereof) of networks or mixtures thereof can be used with system 100.

The network may support or otherwise provide any suitable type of messaging or communication service or system (e.g., e-mail, IM, SMS, EMS, MMS, or the like) and/or combination thereof, and all such services and systems can be configured to utilize the system 100 of the present invention. The network preferably also supports, but is not in any way limited to supporting only, Push-to-Talk (PTT) and Push-to-Talk-over-Cellular (PoC) service.

Each subscriber communication module 104 may belong to the same or different network and, preferably, is able to communicate with any other communication module on the same network or across one or more different networks.

Each subscriber communication module 104 may comprise any suitable type of wireless or wired communication module or device that is capable of receiving and transmitting messages and/or communication and other information using any appropriate type of communication service.

According to an exemplary embodiment, each of the subscriber communication modules 104 preferably comprises a mobile or handheld device (e.g., cellular telephone, personal digital assistant (PDA)), a personal computer (PC), GPS device, or other like communication endpoint. According to a further exemplary embodiment, the subscriber in the aforementioned examples can be a person or an application. Furthermore, each subscriber communication module 104 preferably comprises a positioning determining module 104a for determining the geographic position of the subscriber communications module and an interface 104b, such as a numerical and/or alphanumerical keyboard and/or a touchscreen, for use by the subscriber. As those of ordinary skill in the art can appreciate, although the examples of subscriber communication module 104 implies a person, each of the above aforementioned examples can be used by an application, and further subscriber communication module 104 can include devices not likely to be used by persons.

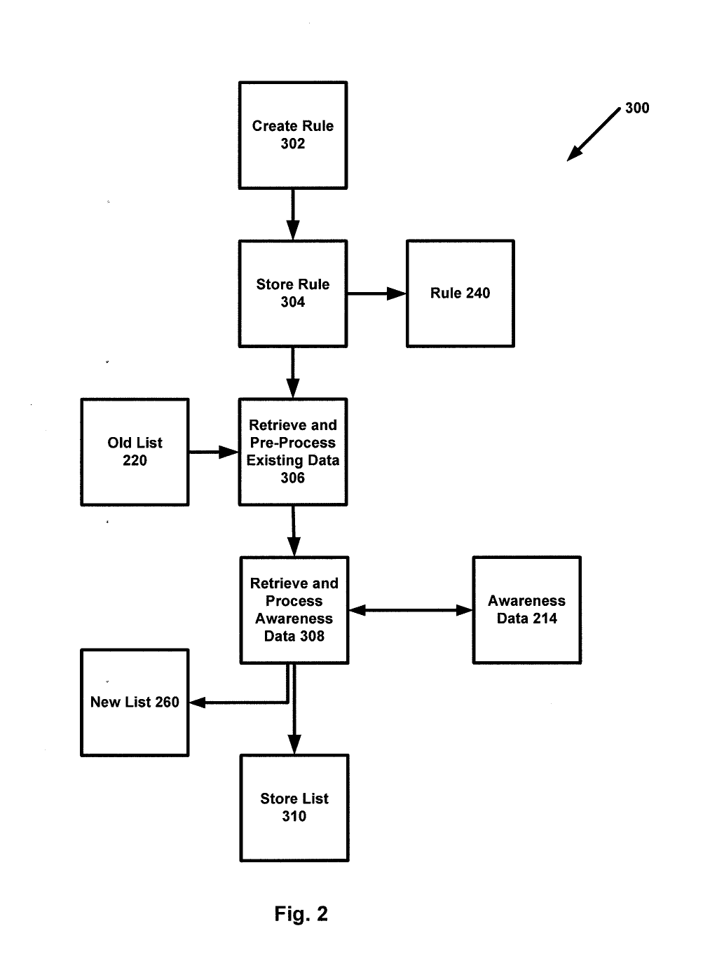

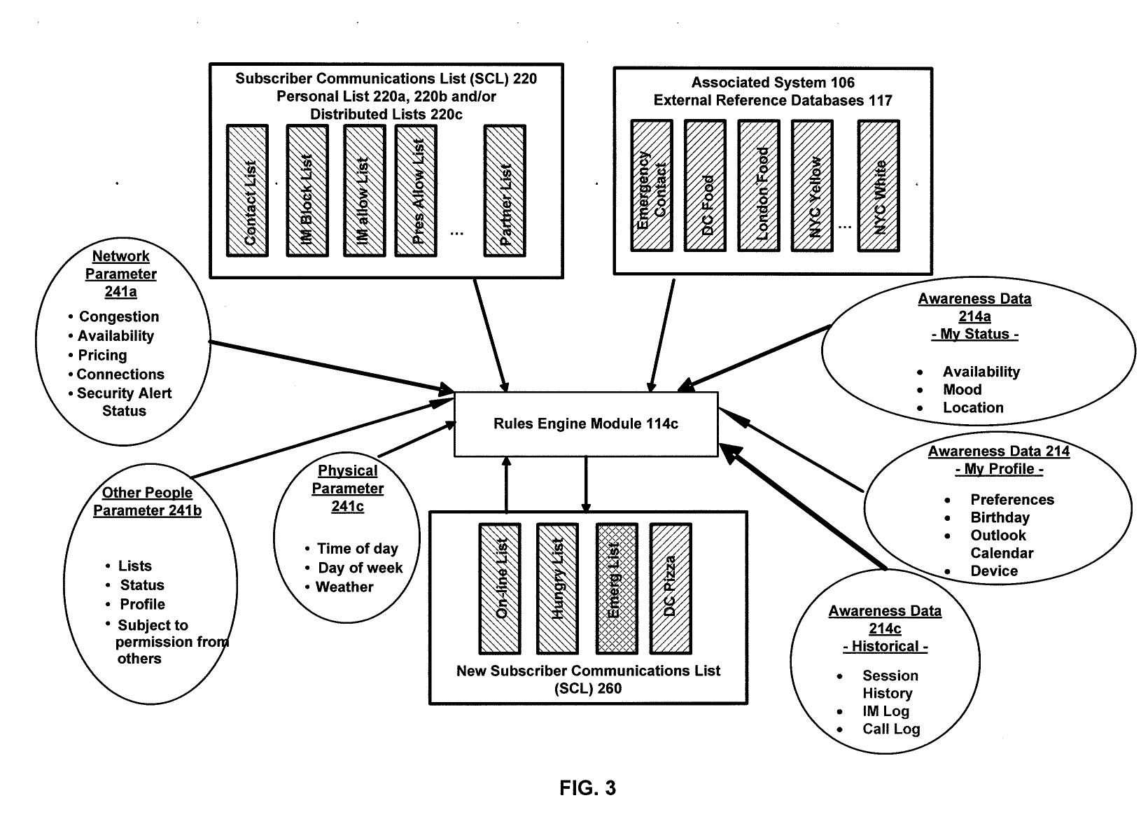

Referring also to FIGS. 2 and 3, in communication system 100, the subscriber may utilize one or more subscriber information data (SID) 200 and arranged in one or more subscriber communications lists (SCL, “list”) 220. As described below, system 100 and method 300 dynamically update one or more subscriber communications lists 220 and/or dynamically create one or more new subscriber communications lists 260 based on awareness information. Therein, new subscriber communication list 260 is created dynamically or an existing SCL 220 is modified to become an updated SCL 260.

SID 200 may comprise any of the data discussed above and any other suitable data that may occur and/or can be captured in relation to the subscriber, an object that the subscriber is watching, and/or a watcher who watches the subscriber. It should be appreciated that SID 200 may also include such data that may be removed by one or more levels from the subscriber; for example, SID 200 may also include data from a watcher who is watching the watcher of the subscriber.

System 100 and/or communication enabler server module 110 may utilize any appropriate communication protocol, but preferably utilizes Session Initiation Protocol (SIP) and SIP for Instant Messaging and Presence Leveraging Extensions (SIMPLE) based IM and presence systems. Such systems are described in, for example: Internet Engineering Task Force (IETF), Network Working Group, Request for Comments (RFC) 3428, “Session Initiation Protocol (SIP) Extension for Instant Messaging” (December 2002); IETF, Network Working Group, RFC 3856, “A Presence Event Package for the Session Initiation Protocol (SIP)” (August 2004); IETF, Network Working Group, RFC 3863, “Presence Information Data Format (PIDF)” (August 2004); IETF, Network Working Group, RFC 2778, “A Model for Presence and Instant Messaging” (February 2000); IETF, Network Working Group, RFC 2779, “Instant Messaging/Presence Protocol Requirements” (February 2000); and IETF, Network Working Group, RFC 3261, “SIP: Session Initiation Protocol” (June 2002).

The communication enabler server module may include a plurality of systems or service modules 112-122: a service enabler module 112, a list management module 114, a system database module 116, a location position module 118, a presence server module 120, and privacy protection module 122.

In the alternative, the service modules 112-122, rather than being a part or a portion of the communication enabler server module 110, may be associated with other functional modules, be disposed across multiple systems, and/or be operative with the communication enabler server module 110. Each service module may be configured stand-alone or may comprise a particular portion of one or more other server modules, and/or may be implemented as hardware, software or a combination of the two.

Service enabler module 112 comprises any suitable enabler that is capable of enabling communication of information between one or more subscribers. Therein, the service enabler may be configured as an IM Service Center, e.g., an IM enabler, a Short Message Service Center (SMSC), Push-to-Talk (PTT) and/or Push-to-Talk-over-Cellular (PoC) enabler, or the like. The service enabler module 112 may be integrated with the communication enabler server module 110.

Although one service enabler module may be illustrated, it should be appreciated any suitable number and types of service enabler modules may be used herein. Thus, a subscriber of the system may be able to utilize wireless service, IM, and PTT communications via a suitably configured subscriber communications module 104.

List management module 114 preferably serves as a dynamic list manager and includes a profiling engine module 114a for profiling a new subscriber and storing a subscriber profile in a storage, a subscription management module 114b for polling and/or subscribing to one or more other subscribers and/or services and storing a subscription, a rules engine module 114c for creating and registering one or more rules in a storage, wherein the rule defines the update to subscriber communications list 220 and defines the new subscriber communications lists 260.

Profiling engine module 114a may also be used to study the subscriber's behavior to obtain data in the form of preference awareness data (PAD). PAD may comprise any suitable amount of information related to the subscriber. For example, the subscriber may have linked one or more financial accounts with the account at the operator. Thus, the subscriber's PAD may comprise purchasing history or data from points reward system related to purchasing on one or more of the linked accounts. Of course, as those of ordinary skill in the art of the present invention can appreciate, PAD need not embody “personal” data, but also data related to an organization and/or an application.

PAD can also include information found from the subscriber in their calendar, contact lists, memos, notes, such as birthday lists, lists of vacation places, shopping lists; in preferences expressed in usage or device settings or expressly answered; and/or devices being used. A PAD can also include awareness data in regard to an organization and/or an application.

PAD may be enhanced, supplemented, corrected, or in any other way manipulated with data obtained from data mining conducted at discrete intervals and/or on a continuous basis using any known means. PAD may comprise data that is relevant to the subscriber and derived from statistical information, marketing data, or any other suitable knowledge. For example, a subscriber may live in area that is well known to support a particular sporting team, team A. Thus, PAD may comprise information “Supporter of Team A” and use that information.

Subscription management module 114b may be used to study the subscriber's behavior to obtain subscriber transaction, e.g., usage awareness data (UAD). UAD may comprise the network operator's knowledge regarding usage history of the network including calling and instant messaging data or logs, session histories in instant messaging programs, locations from which communications are made, lengths of communications, persons contacted, and any data determined by data mining and/or cross-referencing.

System database module 116 may comprise storage and suitable manipulation of the stored data in a plurality of storage modules 116a-116d each for which is associated with one or more gateways. Each storage may be implemented, as is generally known in the art, as one or more databases in any suitable architecture or all storages may be implemented in one or across several databases using any suitable architecture. While a centralized system database module 116 is preferred for reasons of economy, it should be appreciated that system database module 116 may be distributed across multiple systems or modules.

System database module 116 preferably comprises a subscriber profile storage 116a for storing any suitable information of the operator, subscriber, associated networks, watchers, and/or subscriber communications module 104, such as the operator's knowledge of the subscriber's identity and biographical information including PAD; and a subscriber transaction storage 116b for storing usage history, e.g., UAD, of the subscriber with respect to the subscriber communications module, network, and/or associated networks.

System database module 116 may further comprise storage of one or more rules 240 in a rules storage 116c, storage of one or more SCLs 220 in an SCL storage 116d. Each storage is associated with a respective gateway 115a-115d, which may be implemented as software, hardware, or combination thereof and which is mirrored in the list management module to facilitate access to the respective storage.

System database module 116 may also be operative with a database 117, which may be any suitable database and may be located external. For example, database 117 may comprise a list of restaurants maintained by an associated system 106 that may reside physically with associated system 106.

Access to the system database module may be restricted in whole or in part as required by law, regulation, and/or operator's policy. The system database module may be limited to a subset of all information for a particular subscriber and/or subscriber communications module 104.

Presence server module 120 preferably determines a status of the subscriber according to a particular SID 200, a presence information SID, e.g., PSID 210 and may be one form of awareness data. PSID 210 comprises an object presence status (OPS) 212 that the subscriber communications module 104 is enabled or disabled, i.e., is ON or OFF.

Presence server module 120 is preferably operative to permit any suitable level of presence management beyond ON or OFF. To do so, a presence agent is preferably associated with presence server module 120.

PSID 210 may comprise any suitable presence information. This may be indicated manually, dynamically, or both by a watcher subscriber by indicating OPS 212 for plurality of conditions directly or indirectly. For example, a subscriber may utilize the subscriber communications module to indicate a refined ON OPS and forward that information to presence server module 120.

Table 1 lists by example, but not limitation, a plurality of possible indicators for OPS 212. An almost unlimited variety of indicators for OPS 212 is possible and all indicators are contemplated herein.

TABLE 1
Object Presence Status

OFF
ON
ON - BUSY
ON - AWAY
ON - AVAILABLE
ON - TALKING
ON - HUNGRY
ON - MEETING
ON - SHOPPING
ON - NOT AVAILABLE

However, the presence information is not limited to OPS 212 as indicated by a subscriber, as will be discussed.

Location position module 118 preferably makes the location of subscriber communications module 104 available to other service modules and may acquire location of the subscriber communications module from a position determining equipment 104a.

However, location position module 118 may also be configured to determine the position of subscriber communications module 104 at discrete time/distance/position intervals and/or on a continuous basis using any known means. Known means may include triangulation on signal, communications message content analysis, and/or data query.

Privacy protection module 122 may comprise any predetermined rules or information that limit the operation of, or restrict access to, one or more service modules. Privacy protection module 122 may be configured in any suitable manner.

FIG. 2 is a flow diagram of a method for dynamically updating one or more subscriber communications lists and/or dynamically creating one or more subscriber communications lists based on awareness information according to an embodiment of the present invention. System 100 may be used in method 300 to dynamically create new subscriber communications list 260 by creating rule 240 in a creation step 302, storing the rule in, and/or forwarding the rule to, rules engine module 114c, in a forwarding step 304, obtaining SID 200, PSID 210, and/or SCL 220 to use with rule 240 in the rules engine module in a pre-processing step 306, initiating a subscription to another subscriber and/or a service generating new subscriber communications list 260 in rules engine module 114c in processing step 308, and storing new subscriber communications list 260 in SCL storage 116d in storage step 310. According to an exemplary embodiment of the present invention, any entity that creates, manipulates, updates, or in any way modifies SCL 220 to create new subscriber communications list 260, or who uses either or both of SCL 220 and new subscriber communications list 260 can be one or more persons, organizations, or applications, and the one or more applications can represent, or act as an intermediary for the one or more persons and the one or more organizations.

FIG. 3 is a diagram illustrating several factors that can influence rules engine module 114c according to an embodiment of the present invention. Therein, rule 240 defines the update to subscriber communications list 220 or defines new subscriber communications list 260. As used herein, “defines” means that the rule applies awareness information data 214 given one or more parameters 241a-c, which may be any suitable factor, concept, idea, physical or mental association or the like. A parameter 241 may also be awareness information data 214, and vice versa.

For example, a parameter may be network parameter 241a, other people parameter 241b, or physical status parameter 241c. For example, under physical parameter 241c, one parameter may be the day of the week, Monday. Thus, rule 240 may define the update to subscriber communications list 220 or define the new subscriber communications lists 260 to those items that are available on Monday. A further parameter may be the weather (also under physical parameter 241c). Thus rule 240 may define the update to subscriber communications list 220 or defines the new subscriber communications lists 260 to the awareness information data that correlates to good weather and Monday. Yet, in a further example, parameter 241 may be providing ease of consumer services, thus, rule 240 may define the update to subscriber communications list 220 or define the new subscriber communications lists 260 to those items that provide a geographically limited listing of consumer services, e.g., bank branches, automatic teller machines, post office locations, grocery stores, wherein these are selected information awareness data associate with the user, such as that user's bank chain, the grocery store chain where the user's credit card is used or such information as when a marketing campaign for a commercial company or the like provides such information awareness data even when the user does not utilize that commercial company.

System 100 may also be used in a method 300 to dynamically update an existing subscriber communications list 220 by creating a rule 240 in a creation step 302, storing the rule and/or forwarding the rule in rules engine module 114c in forwarding step 304, obtaining SID 200, PSID 210, and/or SCL 220 to use with rule 240 in rules engine module 114c in pre-processing step 306, initiating a subscription to another subscriber and/or a service generating new subscriber communications list 260 in the rules engine module in processing step 308, and storing new subscriber communications list 260 in the SCL storage 116d in storage step 310.

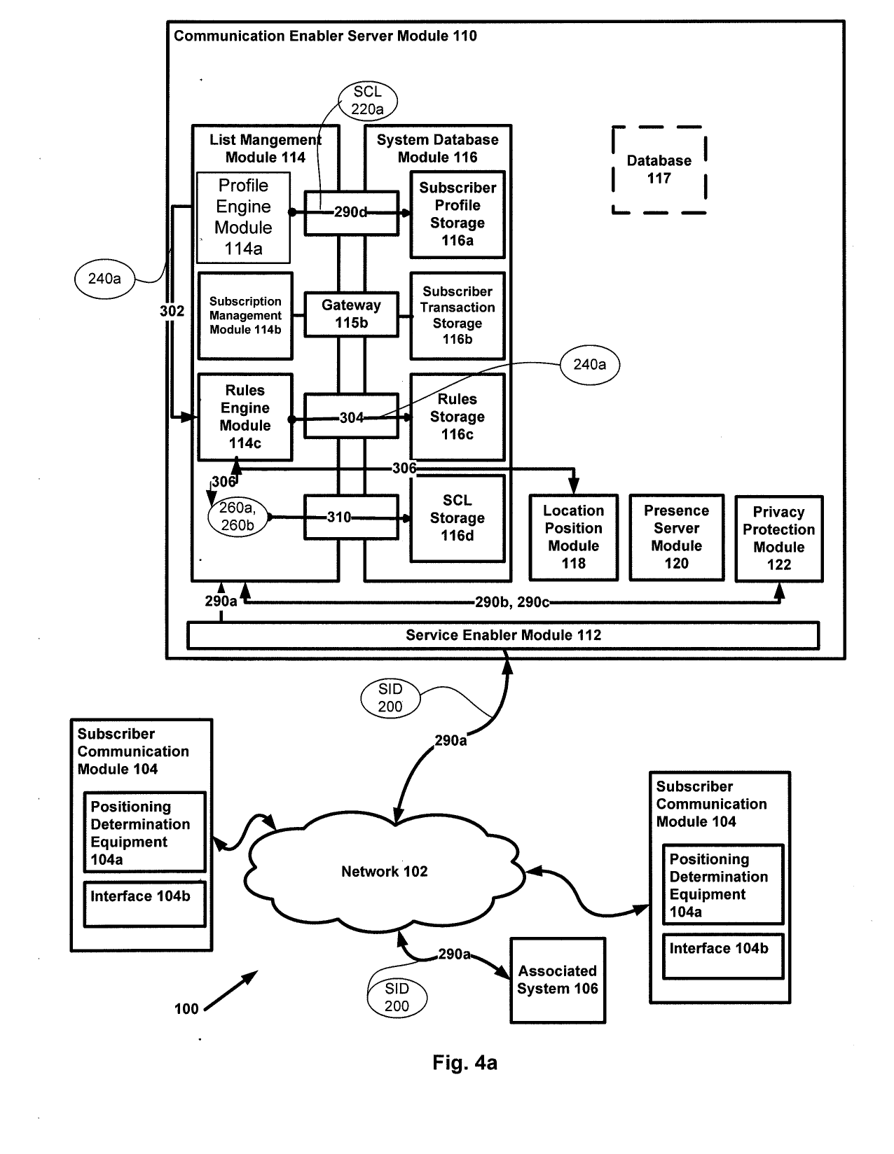

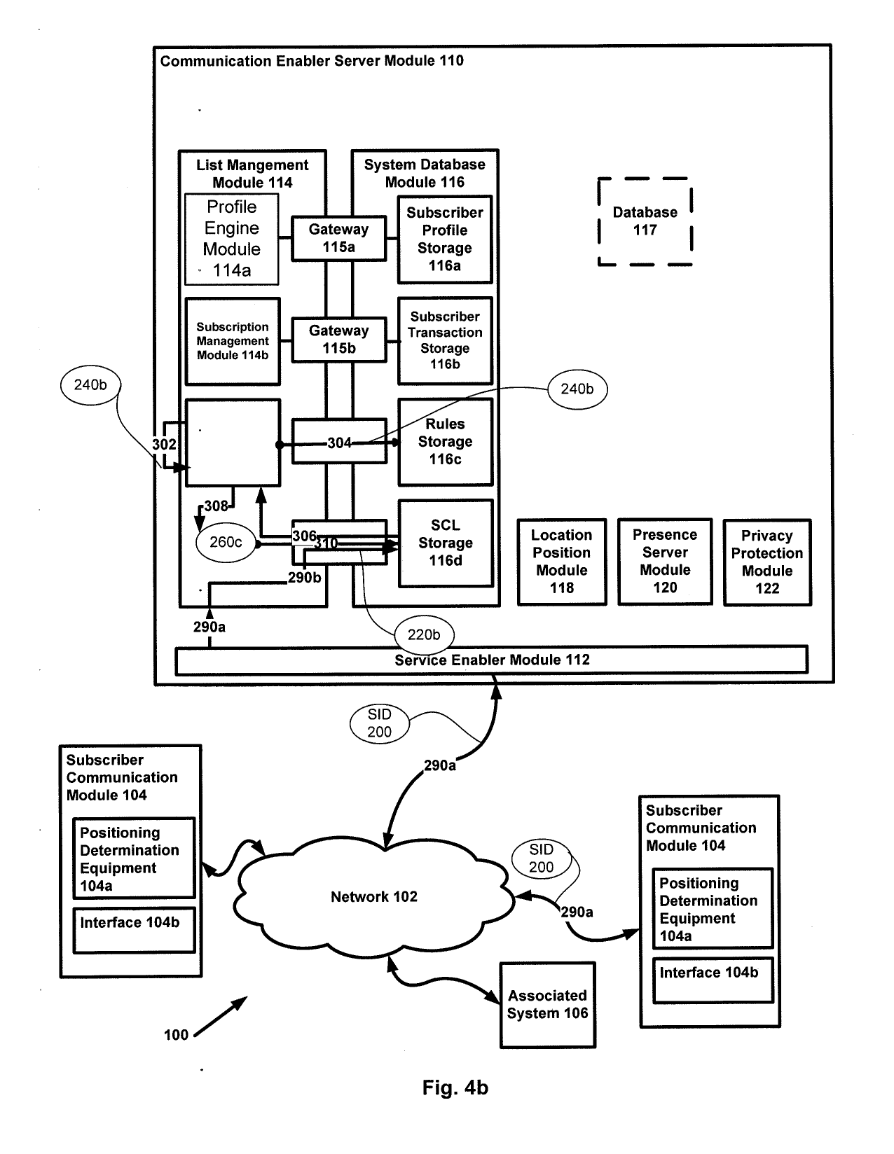

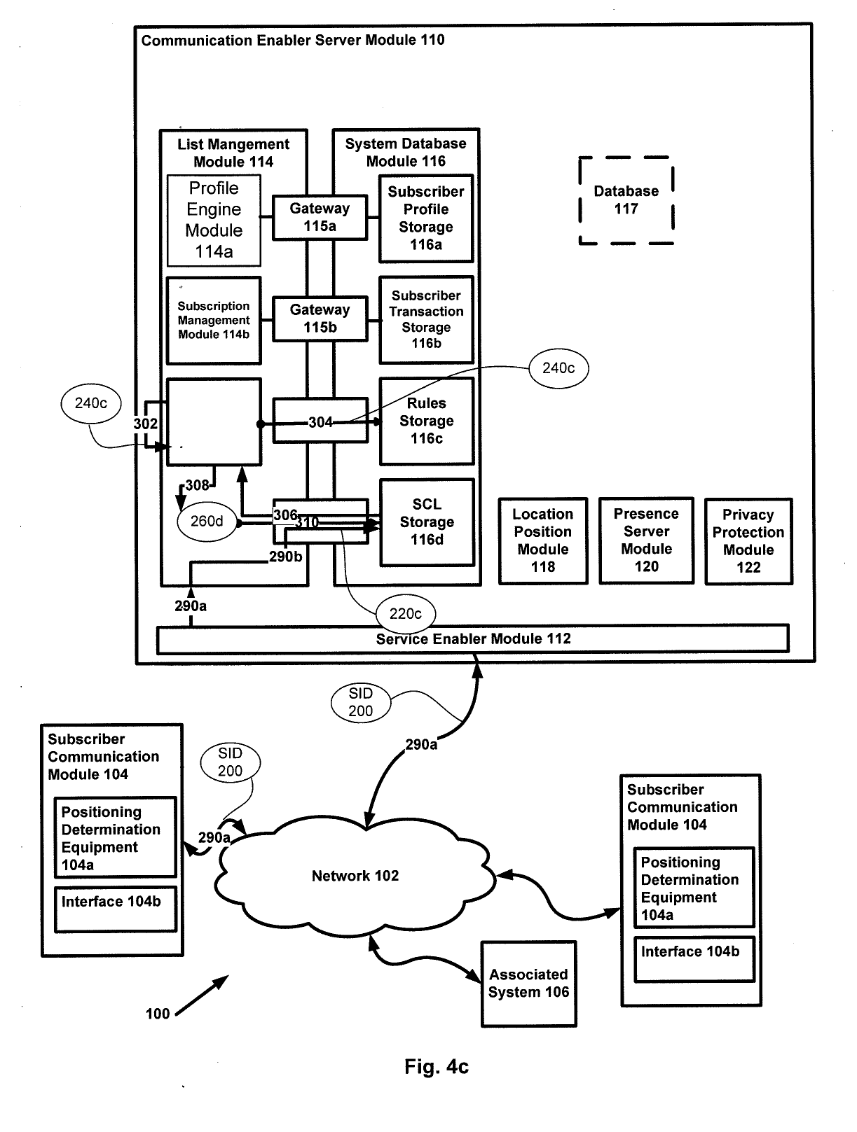

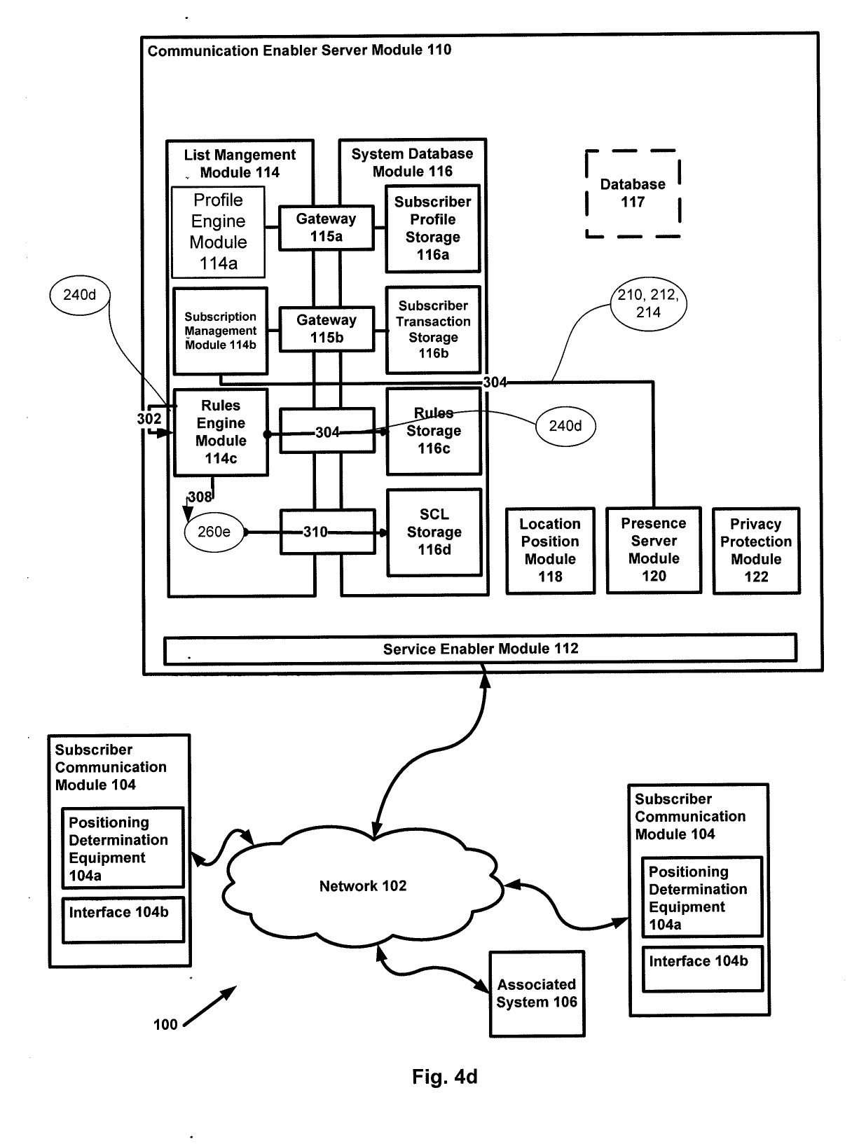

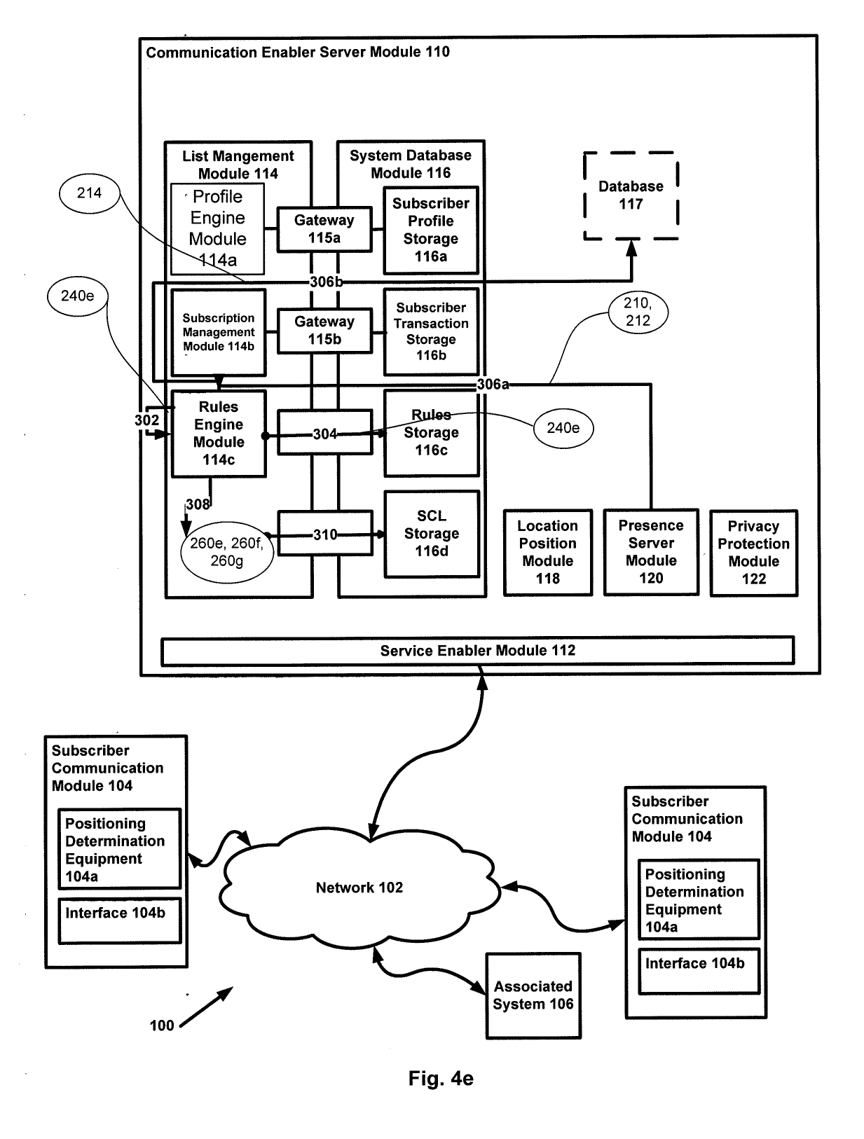

FIG. 4a is a schematic view of the system of FIG. 1 illustrating the method of updating of a subscriber communications list in accordance with one or more embodiments of the present invention. Therein, the creation of one or more new subscriber communications list 260, in this example, new subscriber communications list 260a and new subscriber communications list 260b, according to method 300, preferably begins with the creation of SCL 220, e.g., in this example, SCL 220a, may actually begin with a pre-creation step 290a when a new subscriber becomes active with system 100, such when the subscriber subscribes to system 100.

Therein, the system operator's accounting system, e.g., associated system 106, may forward certain biographical and/or billing information, e.g., subscriber profile data, e.g., SID 200, as shown by way of example in Table 2, to list management module 114. List management module 114 may use profiling engine module 114a to profile this information and directly store the information via profile storage gateway 115a in profile storage 116a or forward this information to privacy protection module 122 in step 290b.

Privacy protection module 122 may evaluate and/or modify the information in view of any suitable or applicable regulatory, legal, and/or ethical framework or rules. In step 290c, privacy protection module 122 returns the permissible information of SID 200 to list management module 114, wherein it is profiled by profile engine module 114a and stored in subscriber profile storage 116a in step 290d.

TABLE 2
Subscriber Profile Data

| | |
|---|---|
| Name | John Smith |
| Location | New York |
| Payment Method | Debit at Bank A |
| Special Program | Yankees Promotion |

Profile engine module 114a may begin the dynamic list creation of method 300. In a list creation step 302, the profiling engine may use the SID to create a rule 240, e.g., rule 240a that identifies keywords in the SID of the subscriber profile.

For example in step 302, profile engine module 114a may recognize “Yankees” and determine that subscriber communications list 220 of Yankees related information would be valuable to the subscriber. Rule 240a is then stored and/or forwarded in step 304 to rules engine module 114c, which copies or generates new subscriber communications list 260, e.g., new subscriber communications list 260a, that provides Yankees information relevant to the subscriber in pre-processing step 306. Thus, in step 308, new subscriber communications list 260a of phone numbers for the Yankees Stadium, various ticket outlets, and the team stores, and/or authorized merchants may be made operable for the subscriber and stored in step 310.

Related thereto, in step 306, rules engine module 114c may copy or generate new subscriber communications list 260b of branch locations of Bank A in the New York area and/or automatic teller machines of Bank A in New York. Rules engine module 114c may then generate, in step 308, new subscriber communications list 260b, and in step 310, forward new subscriber communications list 260b via list storage gateway 115d to list storage 116d for storing and/or registering new subscriber communications list 260b.

A list that was originally created using rules engine module 146 may also be further modified according to method 300. In a rule creation step 302, list management module 114 may task rules engine module 114c to generate a rule according to certain predetermined criteria. Thus, rules engine module 114c may create rule 240 that requires:

1. query the location position module 118 for the subscriber's position at regular intervals; and

2. update SCL 220 with SID relevant to the new position.

Thus, rule 240 will be stored via rule storage gateway 115c to rules storage 116c, and rules engine module 114c will query location position module 118 for the position of the subscriber, which is revealed through positioning determination equipment 104a, in step 306. In step 308, rules engine module 114c updates subscriber communications list 220 and stores new subscriber communications list 260 in step 310.

The effect of rule 240 may be defined that as the subscriber travels, new subscriber communications list 260a or subscriber communications list 260b of available branches and/or automatic teller machines of Bank A may be updated to be even more relevant to the subscriber by updating the list of branches relative to the subscriber's location. Similarly, the SCL of Yankees related information may alter after the end of the season or as the season approaches through one or more rules 240.

FIG. 4b is a schematic view of the system of FIG. 1 illustrating the method of updating of a subscriber communications list in accordance with one or more embodiments of the present invention. Preferably, an SCL 220, e.g., SCL 220b, may have been created by the subscriber in pre-creation step 290a. The subscriber using interface 104b of the subscriber communications module 104 enters various SID 200, such as the telephone numbers and addresses of contacts, and communicates the information via network 102 to communications enabler server module 110, e.g., service enabler module 112, which is operatively connected to the other service modules.

The service enable module 112 passes SID 200 to list management module 114, which in turn, in a step 290b, via list gateway 115c, stores and/or registers the SID in an SCL 220b in list storage 116c. A sample SCL, SCL 220b, may comprise the information shown in Table 3.

TABLE 3
Sample Subscriber Communications List 220b

| | Contact | | | |
|---|---|---|---|---|
| Identity | Information | Location | Remarks | Watch |
| Friend A | 212-555-1234 | New York | (none) | |
| Friend B | 212-555-5678 | New York | | yes |
| Friend C | 212-555-3456 | | | yes |
| Friend D | 212-555-4567 | New York | Running partner | |
| Friend E | 310-555-2345 | Los Angeles | Dodger's fan | |
| Child A | 212-555-5670 | | | yes |
| Family A | 914-555-1234 | White Plains | Birthday Jan. 1 | |
| Family B | 914-555-2234 | Rye | Yankees fan, | |
| | | | Birthday Feb. 1 | |
| Restaurant A | 212-555-5670 | New York | | |
| Restaurant B | 212-555-7777 | | Outdoor eating | |
| Restaurant C | 310-555-7890 | Los Angeles | | |
| Business | 310-555-4567 | Los Angeles | Dodger's fan | |
| Contact B1 | | | | |
| Personal | 212-555-2345 | | Bank A | |
| Contact A | | | | |

In a subsequent step of method 300 to update list 220b to new subscriber communications list 260, e.g., SCL 260c, list management module 114 may task the rules engine module 114c to evaluate SCL 220b and/or one or more additional SCLs. Thus, rules engine module 114c may dynamically generate one or more new rules 240 in step 302 according to one or more predetermined criteria.

By way of an example, presume an associated system 106 provides awareness data in the form of weather forecasts. Rules engine module 116 can then generate a rule 240b that requires:

1. determine weather condition from associated network 108;

2. select SID appropriate to weather condition; and

3. generate new subscriber communications list 260c.

Thus, in step 306, SCL 220b is retrieved, rules engine module 114c process SCL 220b and generates, in step 308, new subscriber communications list 260c that may, when the weather is suitable, be pared down to only include the information of Table 4 and stores new subscriber communications list 260c in step 310.

TABLE 4
Sample Subscriber Communications List 260c

| | | | | |
|---|---|---|---|---|
| | Contact | | | |
| Identity | Information | Location | Remarks | Watch |

| | | | |
|---|---|---|---|
| Friend D | 212-555-4567 | New York | Running partner |
| Family B | 914-555-2234 | Rye | Yankees fan, |
| | | | Birthday Feb. 1 |
| Restaurant B | 212-555-7777 | | Outdoor eating |

In this manner, the subscriber will have a dynamic list of contacts suitable for the weather. For example, the subscriber readily has his running partner's contact information to go running in Central Park or enjoy a meal at a restaurant having outdoor eating.

Furthermore, when the weather is suitable during baseball season, the list may include a family member who enjoys going to a baseball game. Thus, new subscriber communications list 260c may include contact “Family B’ who is a Yankees fan and using SCL 220, and new subscriber communications list 260c may include further contact information related to the Yankees that was generated during the profiling process.

In another example, a new rule 204 may be created that links both subscriber supplied SID with an SCL created by the profiling engine module. Thus, the list of available branches and/or automatic teller machines of Bank A may be updated to be relevant to the subscriber by including Personal Contact A at Bank A.

FIG. 4c is a schematic view of the system of FIG. 1 illustrating the creation of a subscriber communications list in accordance with one or more embodiments of the present invention. In method 300, the creation of new subscriber communications list 260 that is provided to multiple subscribers may begin with any subscriber who is a user of a list 220, e.g., SCL 220c, that embodies SID 200. Preferably, SCL 220c is a list shared by one or more subscribers including a first and a second subscriber.

In pre-creation steps 290a and 290b, as taught above, the second subscriber may create the list 220c using the method taught with respect to creating any list or the list may have been created by any other convenient means. In a further pre-creation step, the second subscriber may then mark the list as being public, e.g., publishes SCL 220c.

In turn, in step 302, a rule 240c is created that the list should be made accessible to predetermined subscribers including a first subscriber. Thus, in step 304, rule 240c is stored and in step 306, rules engine module 114c copies SCL 220c, and in processing step 308 makes list 220c available to the first subscriber as an SCL 260 and in step 310 may store SCL 260. Optionally, the first subscriber may then accept the list by instructing the subscription management module 114b.

FIG. 4d is a schematic view of the system of FIG. 1 illustrating the creation of a subscriber communications list in accordance with one or more embodiments of the present invention. The dynamic creation of an SCL 260, e.g., SCL 260e, according to method 300 or 300 may also begin in step 302 when rule 240d is created that utilizes a change in presence information. Thus, rule 240d may require:

1. poll presence information; and

2. dynamically create an SCL or dynamically update an existing SCL.

Thus, in step 304, the rule is stored. In a pre-processing step 306, rules engine module 114c preferably polls presence server module 120, preferably, on a continuous basis. In effect, subscription management module 114b may be tasked to subscribe to one or more presence information. For example, the presence information may be aware that a subscriber A is a watcher of object subscriber B. Accordingly, a change in presence information may occur when subscriber B changes the OPS from a first indication to a second indication. Thus, in step 308, list management module 114 will recognize the change of presence information 210. List management module 114 may then dynamically modify one or more SCL 220 to create new subscriber communications list 260e in step 308. In step 310, new subscriber communications list 260e is stored.

For example, subscriber Friend B may change an OPS 212 from ON—BUSY to ON—HUNGRY. Thus, in step 306, list management module 114 may create new subscriber communications list 260e of watchers having a changed presence status.

FIG. 4e is a schematic view of the system of FIG. 1 illustrating the creation of a subscriber communications list in accordance with one or more embodiments of the present invention. The list of the prior example, e.g., new subscriber communications list 260d, may be made markedly more useful by including other additional information.

Thus, in accordance with one or more embodiments of the present invention, the inventive method may utilize presence information and awareness data to create new subscriber communications list 260e. The dynamic creation of this list begins in step 302 when rule 240 is created by rules engine module 114c that uses an SID in the form of awareness data 214. Thus, rule 240e may require:

1. poll presence information;

2. if presence information meets predetermined conditions proceed to 3 else proceed to 4;

3. retrieve awareness data; and

4. dynamically create an SCL or dynamically update an existing SCL.

Thus, in step 304, rule 240e is stored. In a pre-processing step 306a, rule engine module 114c preferably polls presence server module 120, preferably, on a continuous basis. In effect, subscription management module 114b may be tasked to subscribe to one or more presence information.

In a subsequent pre-processing step 306b, the presence information meets certain predetermined conditions, awareness data is retrieved. The awareness data may be stored as PAD in subscriber profile storage 116a, as UAD in subscriber transaction storage 116b, and/or it may be stored in any suitable database, such as external database 117. In processing step 308, the awareness data may be utilized to dynamically create new subscriber communications list 260e or update an existing list, e.g., new subscriber communications list 260d, to become new subscriber communications list 260e.

Thus, for the above example, if subscriber B has indicated an ON—HUNGRY status, in step 306a, the change of presence information will be pre-processed by rules engine module 114a. In doing so, one or more conditions will cause the rules engine module 114a to retrieve awareness data 214. The awareness data may be a list of restaurants that have been stored as contacts or a list of restaurants and appropriate data for the list may be obtained from any suitable database, such as database 117.

In accordance with one embodiment of the present invention, by including in the rule a step to query the location position module 118, the rules engine module may make the list more relevant by limiting the restaurants to those within a predetermined distance from the subscriber's location. Thus, Subscriber A for whom new subscriber communications list 260 is being created may then consult his now updated contact list based on restaurants that are in appropriate distance, and choose a suitable restaurant. The subscriber may also receive IM message for one or more restaurants, which may include a coupon or similar promotion.

In fact, by providing an interactive query to the subscriber on, for example, initially on biographical preferences, profiling engine module 114a may collect data that may useful in providing additional awareness data. Thus, rule 240 may include a requirement to limit restaurants meeting one or more dietary restrictions, such as vegan foods. Similarly, rules engine module 114c may utilize data from PAD in step 308 to arrange new subscriber communications list 260 to list restaurants meeting the preferences of the subscriber, such as Indian foods.

SID 200 may be configured to include PAD. For example, a profile of the subscriber's preference may indicate that although in past time period the subscriber preferred one cuisine type to all others, recent behavior indicates a trend toward a new preferred type.

Thus, new subscriber communications list 260e may be configured in step 308 as shown in Table 5. Therein, two restaurants A and B were found in the subscriber A's general communication list, e.g., SCL 220, and two additional restaurant choices R1 and R2 were located in restaurant database, e.g., database 117, that was external to system database module 116 and may have been associated with associated system 106. A third restaurant provided in the subscriber's SCL 220, restaurant C, was not selected from SCL 220 because it was out of the area in Los Angeles while the subscriber was located in New York.

TABLE 5
Sample Subscriber Communications List 260e
Friend B ON - HUNGRY

| Restaurants | Information |
|---|---|
| Restaurant A | 212-555-5670 |
| Restaurant B | 212-555-7777 |
| Restaurant R1 | 212-555-7899 |
| Restaurant R2 | 212-555-7888 |

Similarly, if the subscriber rather than a subscriber is being watched where to change his OPS to ON—HUNGRY, new subscriber communications list 260f may be created that includes suitable restaurants, as shown in Table 6, and would include SID supplied by the subscriber as well as awareness data obtained from external databases.

TABLE 6
Sample Subscriber Communications List 260f

| Restaurants | Information |
|---|---|
| Restaurant A | 212-555-5670 |
| Restaurant B | 212-555-7777 |
| Restaurant R1 | 212-555-7899 |
| Restaurant R2 | 212-555-7888 |

In fact, rules engine module 114c may comprise a behavior analysis module that uses known, suspected, and/or anticipated human or societal behavior rules to analyze and rank information placed in SID. In the example of subscriber A, rules engine module 114c may consider societal, political, religious, and/or other information so as to create awareness data 214 comprising a list of restaurants in the SID in accordance with that information as well or instead of geographical proximity.

Topical information, such as news, whether traditional, entertainment, sporting, or any other may also be included in awareness data. For example, a key player on Team A may have injured himself in practice. The news may be forwarded to Subscriber Z and the like subscribers from the area determined to be generally supporters of Team A.

Profiling engine module 114a may be configured to determine how much time each subscriber, such as Subscriber Z, has spent reading that news and may store this information in subscriber profile storage 116a. When the subscriber indicates an OPS status, such as ON—SHOPPING, system 100 may include this awareness data 214 in step 308 to comprise new subscriber communications list 260g of stores that sell replica team jerseys with the key player's number, or where a product that the key player endorses may be obtained. A sample is shown in Table 7.

TABLE 7
Sample Subscriber Communications List 260g

| Subject | Information |
|---|---|
| Team A store | 212-555-5670 |
| John Smith Jerseys | |
| Available at | |
| Store A | 212-555-7899 |
| Store B | 212-555-7888 |

Since Subscriber Z is not actually known to be a supporter of Team A but rather is inferred to be based on a residential postal code, i.e., zip code, or the like indicator, if Subscriber Z ignores the news the injury, profiling engine module may be configured to note that data and none of the awareness data above, will be used when dynamically creating a list associated with Team A. Thus, in accordance with one embodiment of the present invention, a superuser, such as the network operator or any other operator or suitable authorized entity, may comprises a global list of subscribers that have an interest in a particular topic and distribute a list that may be different for different subscribers.

While subscriber Z is not forwarded new subscriber communications list 260 associated with team A, on the same news, Subscriber Y may be provided with new subscriber communications list 260 providing awareness data comprising programming information for television, radio, and/or any other suitable media related to the possibly improved chances of Team B. Additionally or instead of, the awareness data may comprise a geographically proximate ordered list of outlets selling tickets.

Should unfortunate developments happen to Team B and it is relegated to a lower division in its sport, rules engine module 114c preferably suitably adjust to report on teams of the new division rather than the old.

Even when geographical proximity is a decisive factor in ranking data in new subscriber communications list 260, rules engine module 114c may consider other factors that may be of any suitable nature. For example, a short-term mass transit problem may make reaching a restaurant having a close location impossible. Thus, rather than providing awareness data that places that restaurant at the top of a geographically proximity oriented SCL, another restaurant may be listed or the first one noted to indicate the transit problem.

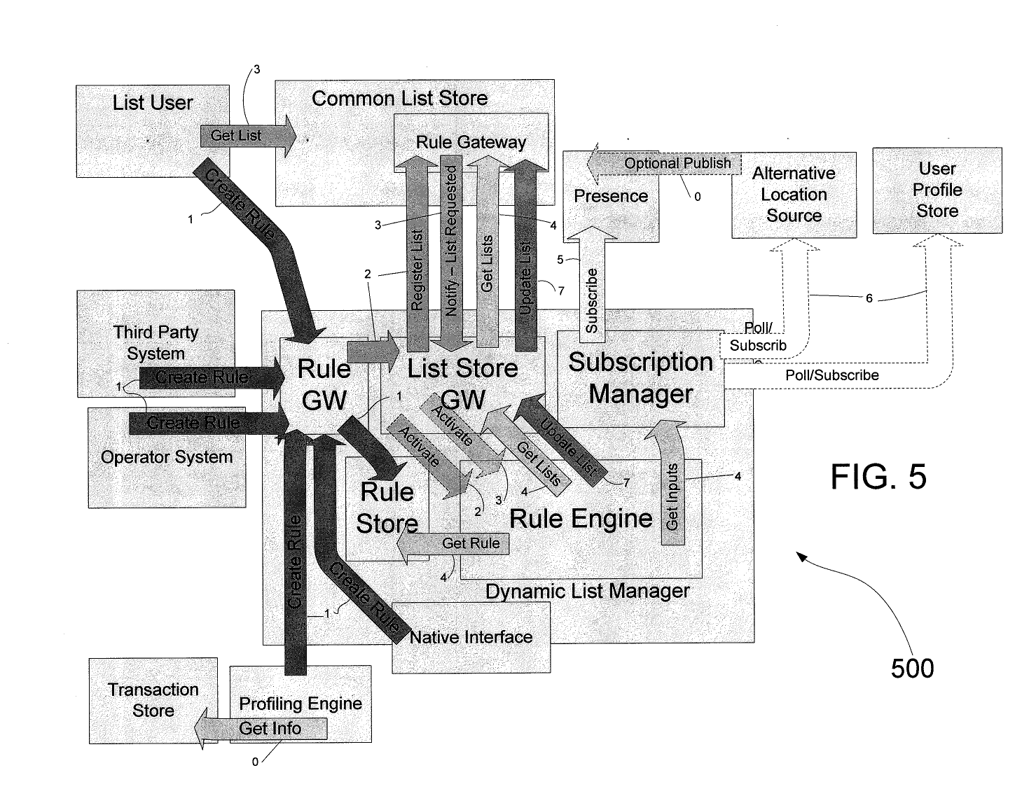

FIG. 5 is a block diagram illustrating communications system (system) 500 in relation to other functional elements it operates alongside for dynamically updating and/or dynamically creating one or more subscriber communications lists based on awareness information according to an additional exemplary embodiment of the present invention.

System 500 comprises a list user, a common list store, a third party system (though not necessarily part of system 500), an operator system, a transaction store, a profiling engine, a dynamic list manager, presence information or data, an alternative location source, and a user profile store. The dynamic list manager comprises a rule gateway, a list store gateway, a subscription manager, a rule engine, a rule store, as well as a native interface. As those of ordinary skill in the art can appreciate, system 500 can operate according to an exemplary embodiment for dynamically updating and/or dynamically creating one or more subscriber communications lists based on awareness information with one or more of the above components not present.

According to a further exemplary embodiment, system 500 for dynamically updating and/or dynamically creating one or more subscriber communications lists based on awareness information operates in the following manner. Optionally, the profiling engine can get information from a transaction store. Optionally the alternative location source can optionally publish to the presence information. One or more of the list user, third party system, operator system, profiling engine or native interface provides a list to the rule gateway located within the dynamic list manager. The rules can be optionally stored in the rule store. The rules are then provided to the list store gateway. The list store gateway registers a list with the rule gateway. Activation can occur between the list store gateway and the rule engine. Alternatively, a list can be obtained by the common list store from the list user. The rule gateway in the common list store notifies the list store gateway a list has been requested. The list store gateway can alternatively initiate an activation between itself and the rule engine. List store gateway gets lists from the rule gateway, or gets lists from the rule engine. The rule engine can provide a rule to the rule store. The rule engine can also get inputs from the subscription manager. The subscription manager subscribes to the presence information. Subscription manager will poll/subscribe with either or both of an alternative location source, or a user profile store. The list store gateway will then update the list in the rule gateway, and the rule engine will update the list in the list store gateway.

According to an exemplary embodiment, a list does not have to be in list store but it can be distributed across multiple systems. A list can be associated with an application user rather than a subscriber. According to an exemplary embodiment, a modified list can be built by applying a rule to a number of input lists. According to still another exemplary embodiment, a presence server can be a list user (Allow/Block), and any application can also be a list user.

According to an exemplary embodiment, a manipulated list can optionally be made to relate to the user using it. That is, the same list may need to look different depending on who is asking for it. Therefore, the rule associated with the list should indicate who the list is for (i.e., both the application and the user the application is acting on behalf of).

According to an exemplary embodiment, the transaction store and profile engine are optional, as is a privacy module. Further still, the transaction store can be distributed across multiple systems. According to an exemplary embodiment, the location information for a given subscriber can be published to the presence server and retrieved from there by the dynamic list manager. Further still, the profile information of the user can be a list in the list store, as can be the privacy module. According to an exemplary embodiment, a list can be created or updated by any application, a rule can be built of other rules, and rules can be modified. Further, according to still another exemplary embodiment, all components can implement privacy logic, or call out to an external privacy module.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method of dynamically updating a first subscriber communications list or creating a new subscriber communications list based on awareness information data, the method comprising:
a. creating a rule for defining a second subscriber communications list, the second subscriber communications list being an updated first subscriber communications list or being a created new subscriber communications list;
b. storing the rule;
c. retrieving and pre-processing existing data;
d. retrieving and pre-processing the awareness information data; and
e. storing the second subscriber communications list.

2. The method of claim 1, wherein the rule is influenced by a parameter.

3. The method of claim 1, wherein the rule comprises keyword identification.

4. The method of claim 1, wherein the rule comprises the step of querying the location position module associated with a subscriber for a position of the subscriber to obtain awareness information data.

5. The method of claim 1, wherein the aware information data comprises information from an external database.

6. The method of claim 1, wherein in step c includes the step of polling a presence server module.

7. A system for dynamically updating a first subscriber communications list or creating a new subscriber communications list based on awareness information data, the system comprising:
a rules engine module for creating and registering a rule, the rule for defining a second subscriber communications list, the second subscriber communications list being an updated first subscriber communications list or being a created new subscriber communications list; and
a system database module for storing the first subscriber communications list and the rule,
wherein the rules engine module process the aware information data according to the rule and generates the second subscriber communications list.

8. The system of claim 7, wherein the rule is influenced by a parameter.

9. The system of claim 7, wherein the rule comprises keyword identification.

10. The system of claim 7, further comprising a location position module associated with a subscriber, the rule querying the location position module for a position of the subscriber to obtain awareness information data.

11. The system of claim 7, wherein the aware information data comprises information from an external database.

12. The system of claim 7, wherein the aware information data comprises information from an external database.
